(19) United States
(12) Patent Application Publication
(10) Pub. No.: US 2009/0108136 A1
(43) Pub. Date: Apr. 30, 2009

(54) Navigation Body, Navigation Device, and Space Navigation Device

(76) Inventor: Kazuyoshi Suzuki, Tokyo (JP)

Correspondence Address: REED SMITH LLP, 3110 FAIRVIEW PARK DRIVE, SUITE 1400, FALLS CHURCH, VA, 22042, US

(21) Appl. No.: 12/227,024

(22) PCT Filed: Jun. 26, 2006
(86) PCT No.: PCT/JP2006/312691

§ 371 Date: Nov. 5, 2008

(51) Int. Cl. B64G 1/28; G01C 19/06

(52) U.S. Cl. 244/165; 74/5.37

(57) ABSTRACT

The present invention provides a thrust generator capable of generating thrust without using reaction of a combustion product, and a navigation body utilizing the same. The thrust generator has a rotation axis, a plurality of tops arranged symmetrically around the rotation axis, and a motor device for rotating the tops around the rotation axis. The spinning axis of the top is arranged along the radial direction of the rotation axis. The “top” generates a force by which it rises perpendicularly from the ground, that is, so-called couple of forces. By using the couple of forces, thrust is generated.

### TECHNICAL FIELD

The present invention relates to a navigation body for navigating space and, more particularly, to a navigation body suitable for navigating outer space.

### BACKGROUND ART

Generally, a device for generating thrust is called an “engine”. There are various engines used for a navigation body that navigates space, such as a jet engine for generating thrust by burning oil fuel and discharging a jet and a rocket engine for obtaining thrust by burning hydrogen and spewing flames. In those engines, a combustion product is injected and, by its reaction, thrust is obtained.

### Patent Document 1: Japanese Unexamined Patent Application Publication No.

### DISCLOSURE OF THE INVENTION

A spacecraft navigating outer space is also propelled by an engine. However, the spacecraft consumes a large amount of fuel to escape from the gravisphere of the earth at the time of lift off. A considerable amount of fuel is also necessary at the time of landing. Therefore, the amount of fuel which can be used to navigate outer space is limited.

An object of the present invention is to provide a navigation body and a navigation device capable of obtaining thrust without using reaction of a combustion product.

According to the present invention, a navigation body has a rotation axis, a plurality of tops symmetrically arranged around the rotation axis, and a motor device for rotating the tops around the rotation axis. The spinning axis of the tops is arranged along the radial direction of the rotation axis.

The “top” generates a force of rising perpendicularly from the ground. By using the force, thrust is generated.

By the navigation body and the navigation device of the present invention, thrust can be obtained without using reaction of a combustion product.

### BRIEF DESCRIPTION OF THE DRAWINGS

FIG. 1 is a diagram showing an example of rotational motion and precession of a top on the earth.

FIG. 2 is a diagram showing an example of rotational motion and precession of a top in nongravity space.

FIG. 3 is a diagram showing an example of rotational motion and precession of a top when the rotation axis of the top is parallel to the horizontal plane.

FIG. 4 is a diagram showing an example of rotational motion and precession of a top when rotational force is applied to the top whose rotation axis is parallel to the horizontal plane.

FIGS. 5A and 5B are diagrams showing comparison between weight of a stationary top and that of a rotating top.

FIG. 6 is a diagram showing forces acting on the gravity center of a top whose rotation axis is parallel to the horizontal plane.

FIGS. 7A and 7B are diagrams showing an example of a thrust generator according to the present invention.

FIGS. 8A and 8B are diagrams showing the operation of the thrust generator according to the present invention.

FIGS. 9A and 9B are diagrams showing a mechanism for generating thrust in the thrust generator according to the present invention.

FIGS. 10A and 10B are diagrams showing a first example of a navigation body according to the present invention.

FIGS. 11A and 11B are diagrams showing a traveling direction of the navigation body according to the present invention.

FIGS. 12A and 12B are diagrams showing another example of the traveling direction of the navigation body according to the present invention.

FIG. 13 is a diagram showing a second example of the navigation body according to the present invention.

FIGS. 14A and 14B are diagrams showing a third example of the navigation body according to the present invention.

FIG. 15 is a diagram showing a first example of a navigation device according to the present invention.

FIG. 16 is a diagram showing a second example of the navigation device according to the present invention.

FIGS. 17A and 17B are diagrams showing the operation of the second example of the navigation device according to the present invention.

FIG. 18 is a diagram showing an example of a space navigation device.

### DESCRIPTION OF REFERENCE NUMERALS

100 top
101 shaft
102 disc
105 ground
106 stand
107 scale
1001 rotary shaft
1002 motor
1004 body
1005A, 1005B arms
1100A, 1100B tops
1101A, 1101B shafts
1102A, 1102B discs
1103A, 1103B motors
1105A, 105B rings
2001 main rotary shaft
2002, 2003 motor units
2004 disk
2005A, 2005B supports
2100A, 2100B, 2100C, 2100D tops
2101A, 2101B shafts
2102A, 2102B discs
2103A, 2103B motor units
2104A, 2104B motor units
2200 external cover
3001 cover
3002A, 3002B, 3004A, 3004B, 3006A, 3006B motor units
3003 outer ring
3005 inner ring
3007 thrust generator
4001 controller
4002A, 4002B, 4002C, 4002D, 4002E, 4002F thrust generators
4003A, 4003B, 4003C control cables
4005 people
4004, 4006 bottom face

### BEST MODES FOR CARRYING OUT THE INVENTION

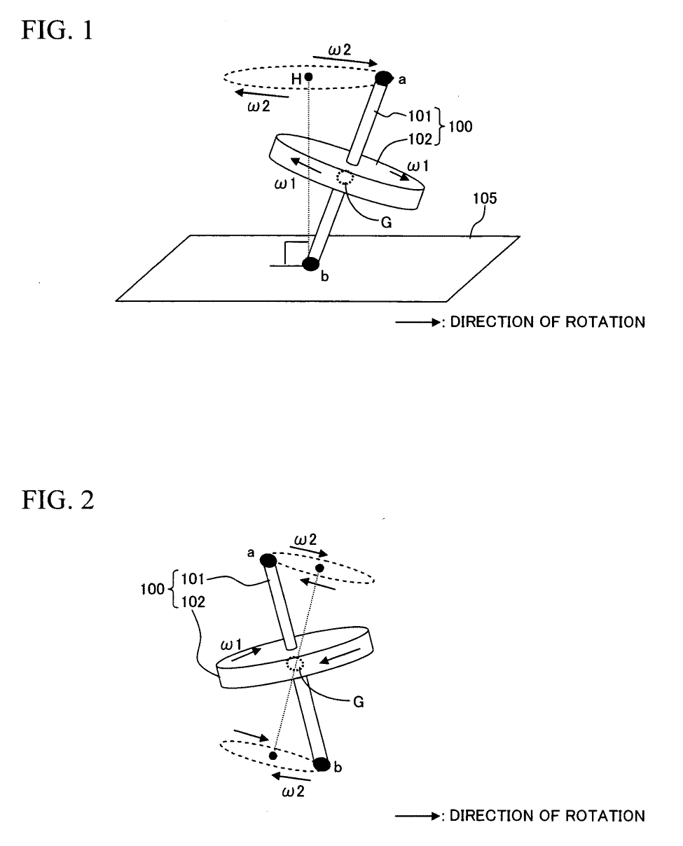

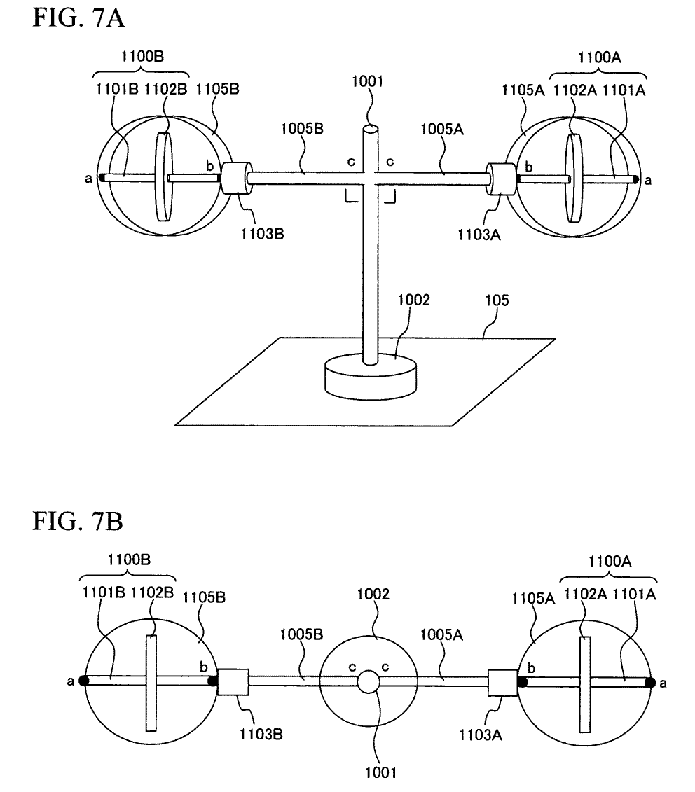

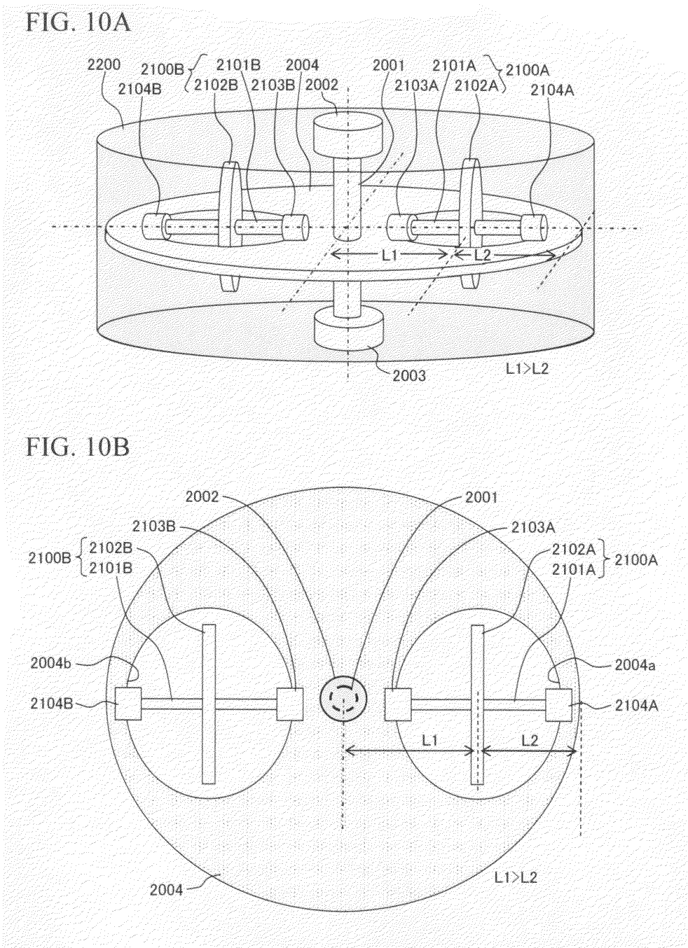

First, the basic characteristics of a top will be described with reference to FIGS. 1 to 6. The basic principles of a thrust generator according to the present invention will be described with reference to FIGS. 7 to 9. Examples of a navigation body and a navigation device according to the present invention will be described in order with reference to FIGS. 10 to 18.

In the description, rotation of an object on an axis passing through its center of gravity will be called rotation, and rotation of an object around an external axis will be called revolution. The term “top” in the description refers to a rigid body rotating on an axis passing through its center of gravity. The rigid body in any shape will be regarded as a “top”. In addition as the earth, an object rotating around its axis in outer space or nongravity space is academically defined as a “top” in general. The object is also regarded as a “top” also in the description. As shown in examples of FIG. 7 and subsequent diagrams, a top whose both axial ends are supported may be called a gyro or gyroscope but will be simply called a “top” in this description.

FIG. 1 shows an example of rotational motion and precession of a top on the earth. A top 100 has a shaft 101 and a disc 102 and has a gravity center G. The top 100 rotates in a clockwise (right-hand turning) direction when viewed from above at a rotational speed ω1.

When the shaft of the top tilts with respect to the vertical direction, although the lower end “b” of the shaft 101 stays in one point on a ground 105, the upper end “a” of the shaft 101 draws a circle around a point H above the lower end “b” of the shaft 101 in a clockwise (right-hand turning) direction when viewed from above at a relatively low rotational speed ω2. The movement of the upper end “a” is precession.

The “precession” is a movement of the tip of the rotary shaft of a top perpendicularly held, which draws a circle parallel to the ground in the same direction as the rotation of the top when the rotary shaft slightly tilts. The movement is also called “MISO (bean paste) grinding movement” or “top head-knocking movement” and is generally known.

FIG. 2 shows an example of rotational motion and precession of a top in nongravity space such as outer space. The top 100 has the shaft 101 and the disc 102 and has the gravity center G. In the nongravity space, the top 100 rotates about an axis passing through the gravity center G in a clockwise (right-hand turning) direction when viewed from one end “a” to the other end “b” at a rotational speed ω1. The top makes the precession. The one end “a” of the shaft 101 draws a circle in a clockwise (right-hand turning) direction when viewed from the one end “a” to the other end “b” at a relatively low rotational speed ω2. The other end “b” of the shaft 101 draws a circle in a clockwise (right-hand turning) direction when viewed from the one end “a” to the other end “b” at a relatively low rotational speed ω2. The gravity center G of the top 100 is held in a predetermined position without oscillation. In such a manner, the top makes the precession also in the nongravity space.

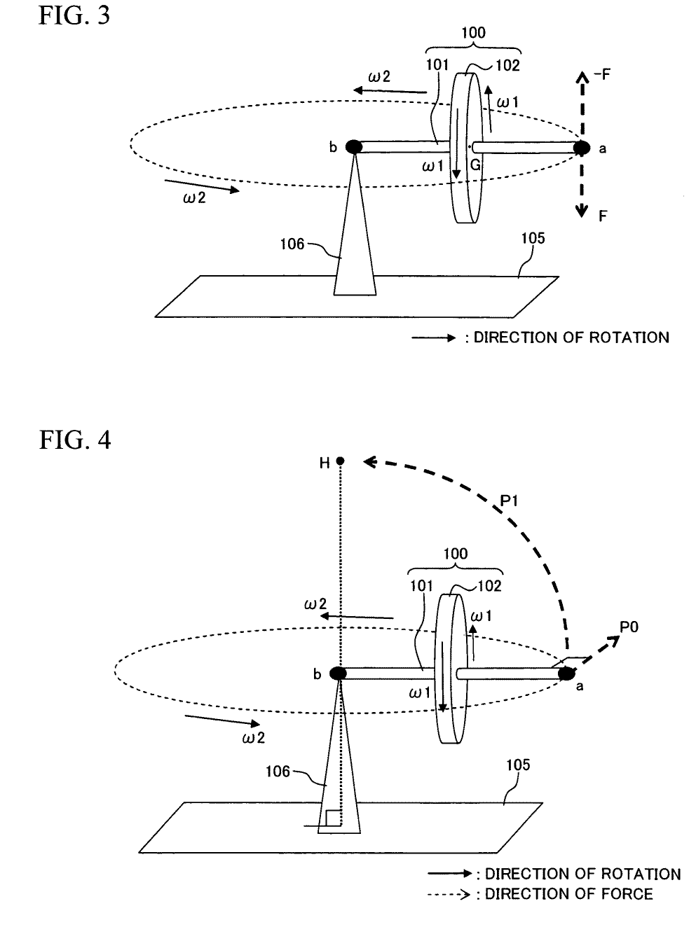

The forces acting on the top will be described with reference to FIG. 3. A stand 106 is installed on the horizontal ground 105. The top 100 has the shaft 101 and the disc 102 and has the gravity center G. The weight of the shaft 101 is sufficiently smaller than that of the disc 102, and the weight of the top 100 is almost equal to that of the disc 102. Therefore, the gravity center G of the top is equal to that of the disc 102. The top 100 rotates in a counterclockwise (left-hand turning) direction when viewed from one end “a” to the other end “b” at a rotational speed ω1. The top 100 makes the precession in a state where the shaft 101 is in an almost horizontal direction. The lower end “b” of the shaft is at the tip of the stand 106. The upper end “a” of the shaft draws a circle in the counter clockwise (left-hand turning) direction when viewed from above at a relatively low rotational speed ω2.

Gravity acts on the gravity center C of the top 100. When the shaft of the top is in an almost horizontal direction, it is supposed that a force or moment acting upward is generated to cancel out the gravity. This phenomenon will be described in detail later.

Referring to FIG. 4, forces which act in the case where the precession is added from the outside to the top will be described. The top 100 rotates in a counterclockwise (left-hand turning) direction when viewed from one end “a” to the other end “b” at the rotational speed ω1. The top 100 makes the precession in a state where the shaft 101 is in an almost horizontal direction. The upper end “a” of the shaft draws a circle in the counterclockwise (left-hand turning) direction when viewed from above at a relatively low rotational speed ω2. A rotational force P0 in the same direction as that of the precession is applied to the upper end “a” of the shaft 101. That is, the precession is added from the outside to the top 100. As a result, the rotational speed in the precession of the top 100 increases. When orbital speed of the top 100 due to the precession increases, a force P1 for making the top 100 rise is generated. The higher the rotational force P0 given to the top 100 is, the larger the force P1 for making the top 100 rise is. The top 100 stands perpendicularly on the stand 106, and the tip “a” of the shaft 101 is disposed in a point H on the center axis of the stand 106. When the rotational force P0 applied to the top 100 is set to be sufficiently large, a force large enough to lift the top 100 can be also generated.

With reference to FIGS. 5A and 5B, the weight of a stationary top and that of a rotating top are compared with each other. The weight of the top 100 is denoted by “w”, and that of the stand 106 is denoted by “Ws”. FIG. 5A shows a state where the stand 106 and the stationary top 100 are put on a scale 107 to measure their weights. The total weight is expressed as w+Ws. FIG. 5B shows a state where the stand 106 and the rotating top 100 are put on a scale to measure their weight. The top 100 rotates in a counterclockwise (left-hand turning) direction when viewed from one end “a” to the other end “b” at the rotational speed ω1. The top 100 makes the precession in a state where its axis is in an almost horizontal direction. Their total weight is expressed as w+Ws.

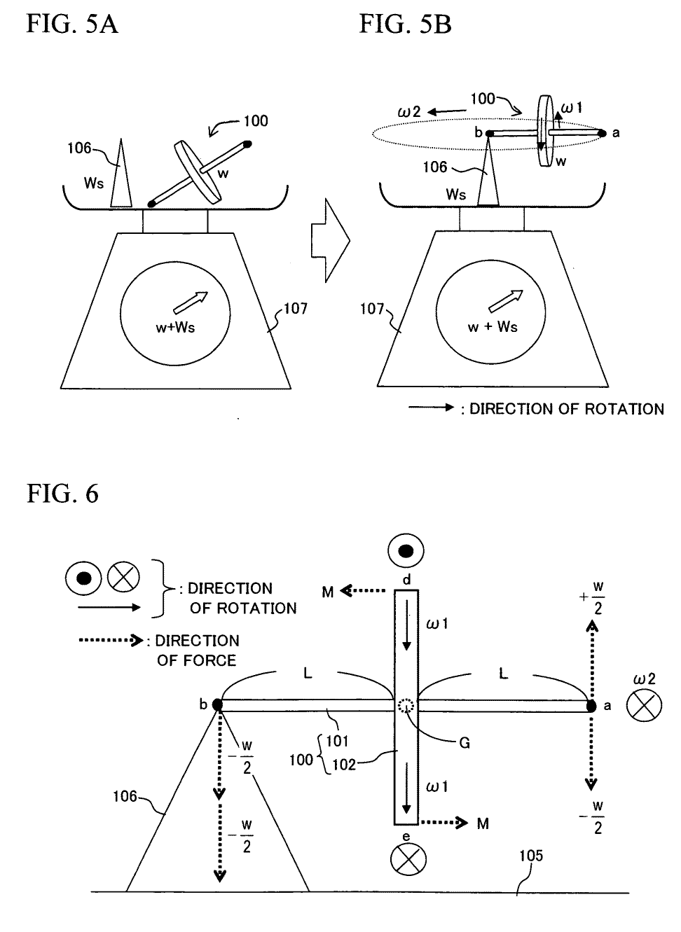

With reference to FIG. 6, the forces acting on the top will be described in detail. FIG. 6 is an enlarged view of the stand and the top illustrated in FIG. 3. The stand 106 is installed on the horizontal ground 105. The top 100 has the shaft 101 and the disc 102, and has the gravity center G. The top 100 rotates in a counterclockwise (left-hand turning) direction when viewed from one end “a” to the other end “b” at the rotational speed ω1. The top 100 makes the precession in a state where its axis is in an almost horizontal direction. The lower end “b” of the shaft is at the tip of the stand 106, and the upper end “a” of the shaft draws a circle in a counterclockwise (left-hand turning) direction when viewed from above at a relatively low rotational speed ω2.

The length of the shaft 101 is denoted by 2L, and the gravity center G is assumed to be in the center of the disc 102. Each of the distance from the upper end “a” of the shaft 101 to the gravity center G and the distance from the lower end “b” to the gravity center is denoted by L. The weight of the top is denoted by “w”.

It is assumed that the weight “w” of the top is supported by the upper end “a” and the lower end “b” of the shaft. Therefore, at the upper end “a” of the shaft, weight w/2 acts downward. At the lower end “b” of the shaft, weight w/2 acts downward.

Generally, the top rotating on the ground has restoring force of maintaining the rotation axis in the perpendicular direction. By the restoring force, rotation moment M for rotating the top about the gravity center G in a counterclockwise direction in FIG. 6 is generated. The rotation moment M generates a force acting upward at the upper end “a” of the shaft, and generates a force acting downward at the lower end “b” of the shaft. At the upper end “a” of the shaft, both the weight w/2 acting downward due to the weight “w” of the top and a force w/2 being generated by the rotation moment in the counterclockwise direction and acting upward are balanced and cancel out each other. Therefore, the upper end “a” floats in the air. On the other hand, at the lower end “b” of the shaft, both the weight w/2 acting downward due to the weight “w” of the top and the force w/2 being generated by the rotation moment in the counterclockwise direction and acting downward are combined, and a force w (=w/2+w/2) acting downward is generated. Therefore, the weight “w” of the top acts on the stand 106.

In the example of FIG. 6, the rotation moment M in the counterclockwise direction and the weight “w” of the top are balanced, and the shaft of the top is held in the horizontal direction. However, when the rotation speed and the revolution speed of the top increase, the rotation moment M becomes larger than the weight “w” of the top. In this case, the shaft of the top rises and moves to the perpendicular direction. On the other hand, when the rotation speed and the revolution speed of the top decrease, the rotation moment M becomes smaller than the weight “w” of the top. In this case, the shaft of the top goes down.

The rotation moment M can be replaced with a force couple F having the gravity center G of the top as a “fulcrum” and having as “points of force” both ends of the diameter of a circle with the gravity center G of the top as its center. The force couple acts using an upper end “d” and a lower end “e” of the disc as points of application. That is, due to the influence of precession, the top uses the gravity center G at a coordinate point in space at a certain time point as a “fulcrum”, and by itself generates a force which will tilt the disc of the top in a predetermined direction using the “fulcrum” as a center, that is, a force couple. The force couple increases as the rotation speed or revolution speed of the top increases. If a component of one of the force couple can be converted to a force acting in the straight-line direction and the resultant force can be taken out, it can be forecasted that the top can create a “fulcrum” of itself at an arbitrary point in space and, on the basis of the fulcrum, generate thrust by itself.

As will be described below, according to the present invention, self-contained thrust in an arbitrary straight-line direction can be taken out by using the principle of the top.

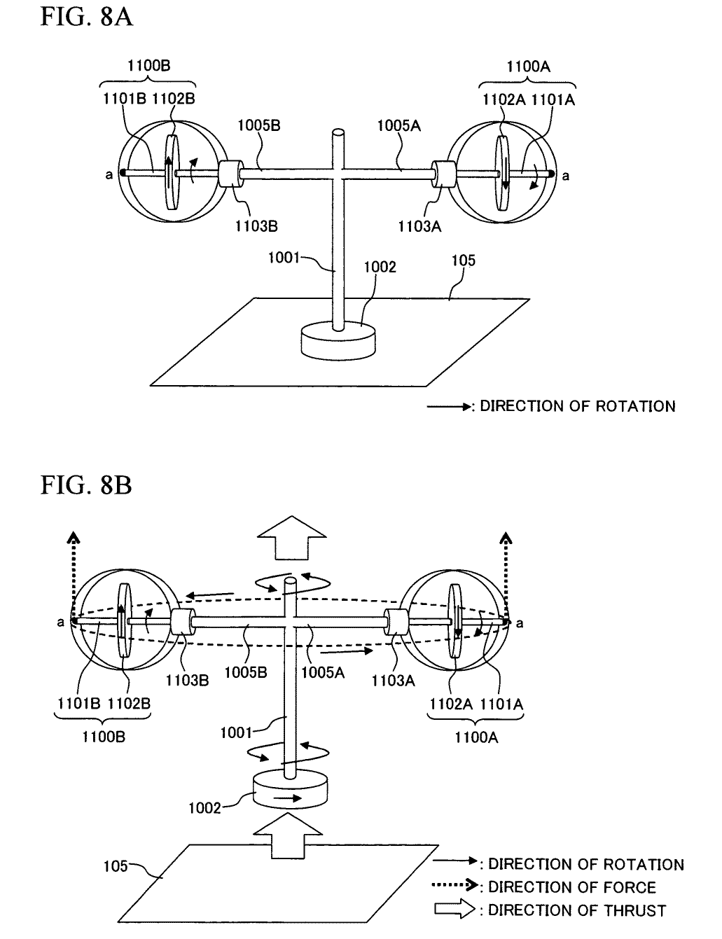

An example of a thrust generator according to the present invention will be described with reference to FIGS. 7A and 7B and FIG. 8. FIG. 7A is a diagram showing the appearance of a thrust generator according to the present invention. FIG. 7B is a diagram showing a configuration in plan view of the thrust generator according to the present invention. A rotary shaft 1001 is rotatably perpendicularly-attached on the horizontal ground 105. A motor 1002 is attached to the lower end of the rotary shaft 1001.

A pair of arms 1005A and 1005B are fixed to their respective sides in the diameter direction of the rotary shaft 1001. The arms 1005A and 1005B are disposed so as to be orthogonal to the rotary shaft 1001 and symmetrical with respect to it.

A top 1100A is attached to the arm 1005A. The top 1100A has both a shaft 1101A having an outer end “a” and an inner end “b” and a disc 1102A. To the arm 1005A, a ring 1105A for rotatably supporting the outer end “a” and the inner end “b” of the shaft 1101A and a motor 1103A for rotating the top 1100A are attached. The shaft 1101A of the top 1100A is disposed along the axis of the arm 1005A.

Similarly, a top 1100B is attached to the other arm 1005B. The top 1100B has both a shaft 1101B having an outer end “a” and an inner end “b” and a disc 1102B. To the arm 1005B, a ring 1105B for rotatably supporting the outer end “a” and the inner end “b” of the shaft 1101B and a motor 1103B for rotating the top 1100B are attached. The shaft 1101B of the top 1100B is disposed along the axis of the arm 1005B.

Referring to FIGS. 8A and 8B, the operation of the thrust generator of the present invention will be described. As shown in FIG. 8A, the tops 1100A and 1100B rotate in the counterclockwise (left-hand turning) direction when viewed from the outer end “a” to the inner end “b”. As shown in FIG. 8B, the rotary shaft 1001 is rotated in the counterclockwise (left-hand turning) direction when viewed from above by the motor 1002. That is, the precession is added from the outside to the tops 1100A and 1100B. Rotation moment passing through the gravity center of the tops 1100A and 1100B is generated. By the rotation moment, upward thrust is generated. That is, the arms 1005A and 1005B, the rotary shaft 1001, and the motor 1002 are lifted up.

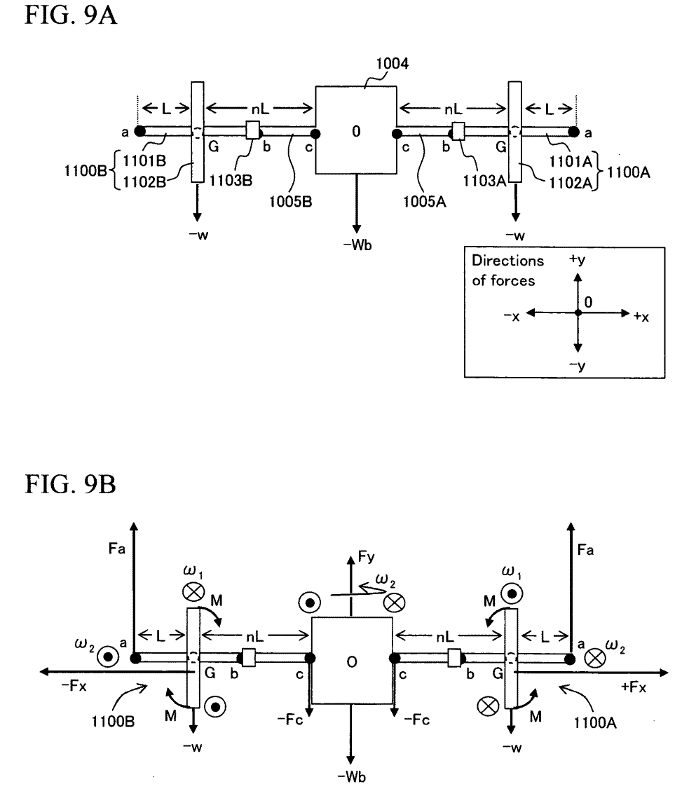

A mechanism for generating the thrust by the thrust generator of the present invention will be described with reference to FIGS. 9A and 9B. FIGS. 9A and 9B are schematic diagrams showing the thrust generator shown in FIGS. 7A and 7B and FIGS. 8A and 8B. The rotary shaft 1001 and the motor 1002 are replaced with a body 1004. The weight of the body 1004 is denoted by Wb and the weight of the arms 1005A and 1005B is ignored. The weight of each of the tops 1100A and 1100B is denoted by “w”. It is assumed that the mass of the tops 1100A and 1100B is concentrated on the gravity center G.

As shown in FIG. 9A, when the tops 1100A and 1100B are stationary, the force Wb in the gravity direction acts on the gravity center G of the body 1004, and the forces “w” in the gravity direction act on their respective gravity centers G of the tops 1100A and 1100B. As shown in FIG. 9B, the tops 1100A and 1100B are rotated in the counterclockwise (left-hand turning) direction when viewed from the outer end “a” to the inner end “b” at the rotational speed ω1. Further, the body 1004 is made revolve in the counterclockwise (left-hand turning) direction when viewed from above at the rotational speed ω2. As a result, the rotation moments about their respective gravity centers G of the tops 1100A and 1100B are generated.

The direction of the rotation moment is the counterclockwise (left-hand turning) direction on the right side of FIG. 9B, and it is the clockwise (right-hand turning) direction on the left side of FIG. 9B. Therefore, at the outer end “a” of each of the tops 1100A and 1100B, an upward force Fa is generated. In a root position “c” of each of the arms 1005A and 1005B, a downward force Fc is generated.

A distance from the gravity center G of each of the tops 1100A and 1100B to the root position “c” of each of the arms 1005A and 1005B is denoted by nL, and a distance from the gravity center G of each of the tops 1100A and 1100B to its outer end “a” is denoted by L. The rotation moment M about the gravity center G of each of the tops 1100A and 1100B is expressed by the following equation.

M=L×Fa=nL×Fc Equation 1

As shown in FIG. 9A, the gravity center O of the body is set as the origin, the X axis is set in the right direction of FIG. 9A, and the Y axis is set in the perpendicular direction. It is assumed that the gravity center O of the body 1004 and their respective gravity centers G of the two tops 1100A and 1100B are on a straight line.

Forces acting on the system are a force Wb acting on the gravity center O of the body 1004, the forces “w” acting on their respective gravity centers G of the tops 1100A and 1100B, and forces Fa and Fc caused by the rotation moments M generated by the tops 1100A and 1100B. The thrust is denoted by Fy. The thrust Fy is the difference between the upward force and the downward force. The thrust Fy is expressed by the following equation.

Fy=2Fa−2Fc−Wb−2w Equation 2

By the equation 1, Fa=M/L and Fc=M/nL. When those are substituted into the equation 2, the following equation is obtained.

Fy=(1−1/n)(2M/L)−(Wb+2w) Equation 3

To make the thrust Fy positive, it is required that the right side of Equation 3 is positive. Therefore, it is sufficient that the following inequality expression is satisfied.

M>(Wb+2w){n/2(n−1)}L Equation 4

The magnitude M of the rotation moment is the function of the rotation speed ω1 and the revolution speed ω2 of the tops 1100A and 1100B. Generally, when the rotation speed ω1 increases, the rotation moment increases. When the revolution speed ω2 increases, the rotation moment increases. When the rotation speed ω1 and/or the revolution speed ω2 are/is increased to generate the rotation moment M which satisfies the equation 4, the upward thrust Fy is obtained. As shown in the diagram, centrifugal forces Fx act on their respective gravity centers G of the tops 1100A and 1100B and cancel out each other. Therefore, the thrust in the X axis direction is not generated.

An example of realizing an actual thrust device and an example of realizing a navigation device using the thrust device will be described on the basis of the thrust generation principle with reference to FIGS. 10 to 18.

FIGS. 10A and 10B show a first example of a navigation body using the thrust generator according to the present invention. FIG. 10A shows the appearance of the navigation body of the example. The navigation body of the example has a main rotary shaft 2001, a disk 2004 attached so as to be orthogonal to the main rotary shaft, motor units 2002 and 2003 attached at both ends of the main rotary shaft, and an external cover 2200 for housing those components. FIG. 10B shows a configuration in plan view of a part obtained by removing the external cover 2200 from the navigation body of the example.

Bearings rotatably supporting the main rotary shaft 2001 are provided in the motor units 2002 and 2003. In the disk 2004, two holes 2004a and 2004b are formed on both sides in the diameter direction. Tops 2100A and 2100B are attached to the holes.

The top 2100A has a shaft 2101A and a disc 2102A. Motor units 2103A and 2104A supported by the disk are attached at both ends of the shaft 2101A. The motor units 2103A and 2104A are provided with bearings rotatably supporting the shaft 2101A.

Similarly, the top 2100B has a shaft 2101B and a disc 2102B. Motor units 2103B and 2104B supported by the disk are attached at both ends of the shaft 2101B. The motor units 2103B and 2104B are provided with bearings rotatably supporting the shaft 2101B.

A distance from the gravity center of each of the tops 2100A and 2100B to the center of the main rotary shaft 2001 is denoted by L1, and a distance from the gravity center of each of the tops 2100A and 2100B to the outer end of the disk 2004 is denoted by L2. The ratio of the two distances is denoted by “n”. That is, L1/L2=n. In this case, the arguments of the equations 1 to 4 hold good.

The tops 2100A and 2100B are rotated by the motor units 2103A, 2104A, 2103B and 2104B, and the main rotary shaft 2001 is rotated by the motor units 2002 and 2003. On the gravity center of each of the tops, the rotation moment and the centrifugal force act. The rotation moment is generated in the shaft of each of the tops, so that the navigation body obtains upward thrust.

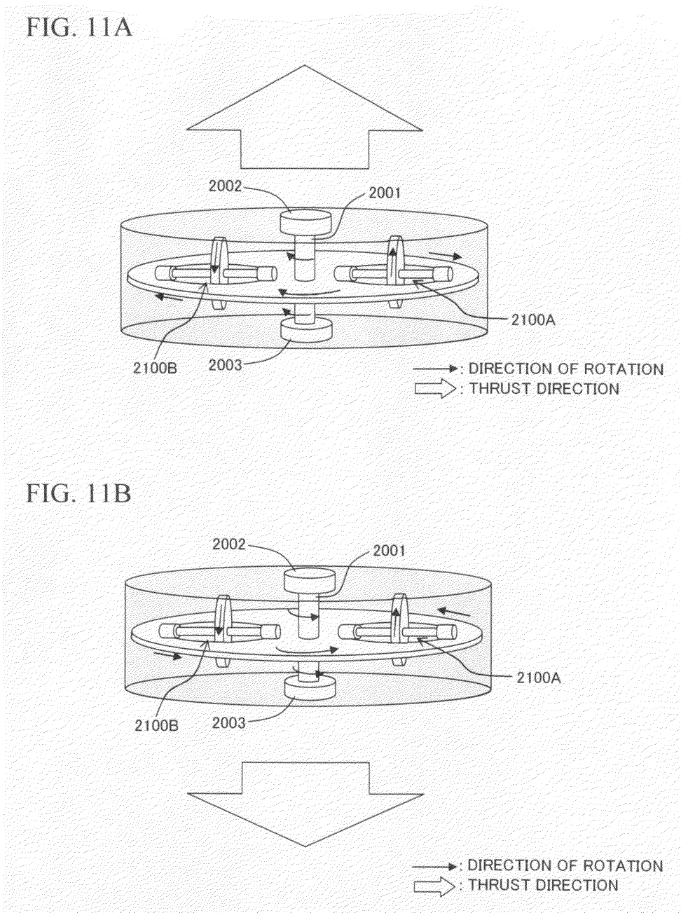

With reference to FIGS. 11A and 11B, the thrust direction of the navigation body will be described. In the example, the navigation body is in such a posture that the main rotary shaft 2001 is oriented toward the perpendicular direction. The tops 2100A and 2100B are rotated in the counterclockwise (left-hand turning) direction when viewed from the inside in the radial direction to the outside.

In the example of FIG. 11A, the main rotary shaft 2001 is rotated in the clockwise (right-handed turning) direction when viewed downward from just above the navigation body, by the motor units 2002 and 2003. By the rotation, the navigation body of the example can generate thrust in the upward direction, that is, the direction opposite to the traveling direction of a right-hand screw.

In the example of FIG. 11B, the main rotary shaft 2001 is rotated in the counterclockwise (left-handed turning) direction when viewed downward from just above the navigation body, by the motor units 2002 and 2003. By the rotation, the navigation body of the example can generate thrust in the downward direction, that is, the direction opposite to the traveling direction of a right-hand screw.

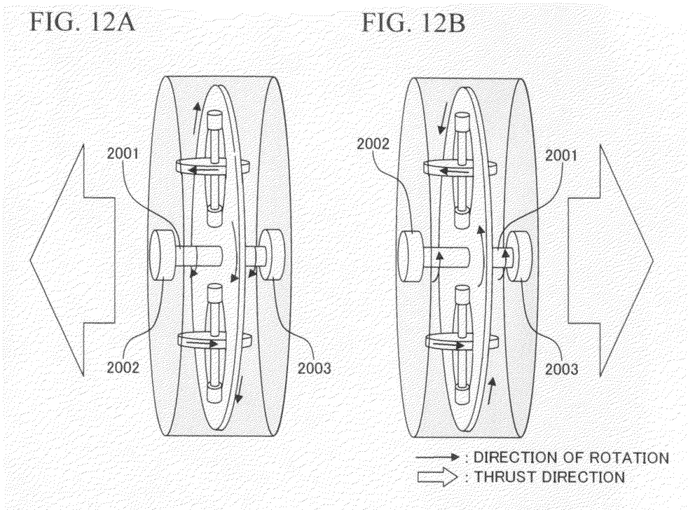

With reference to FIGS. 12A and 12B, another example of the thrust direction of the navigation body will be described. In the example, the navigation body is in such a posture that the main rotary shaft 2001 is oriented toward the horizontal direction. The tops 2100A and 2100B are rotated in the counterclockwise (left-hand turning) direction when viewed from the inside in the radial direction to the outside.

In the example of FIG. 12A, the main rotary shaft 2001 is rotated in the clockwise (right-handed turning) direction when viewed from the left side to the right side of the navigation body, by the motor units 2002 and 2003. By the rotation, the navigation body of the example can generate thrust in the left direction, that is, the direction opposite to the traveling direction of a right-hand screw.

In the example of FIG. 12B, the main rotary shaft 2001 is rotated in the counterclockwise (left-handed turning) direction when viewed from the left side of the navigation body to the right side, by the motor units 2002 and 2003. By the rotation, the navigation body of the example can generate thrust in the right direction in FIG. 12B, that is, the direction opposite to the traveling direction of a right-hand screw.

A distance from the gravity center of each of the tops to the center of the main rotary shaft 2001 is denoted by L1, and a distance from the gravity center of each of the tops to the outer end of the disk 2004 is denoted by L2. The ratio of the two distances is denoted by “n”. That is, L1/L2=n. In this case, the arguments of the equations 1 to 4 hold good.

As understood from the examples of FIGS. 11A and 11B and FIGS. 12A and 12B, when the rotation direction of the tops 2100A and 2100B is the counterclockwise (left-hand turning) direction when viewed from the inside in the radial direction to the outside, upon taking the main rotary shaft 2001 as a right-hand screw, it follows that thrust in the direction opposite to the traveling direction of the right-hand screw can be generated. On the contrary, when the rotation direction of the tops 2100A and 2100B is the clockwise (right-hand turning) direction when viewed from the inside in the radial direction to the outside, upon taking the main rotary shaft 2001 as a right-hand screw, it follows that the thrust in the traveling direction of the right-hand screw can be generated.

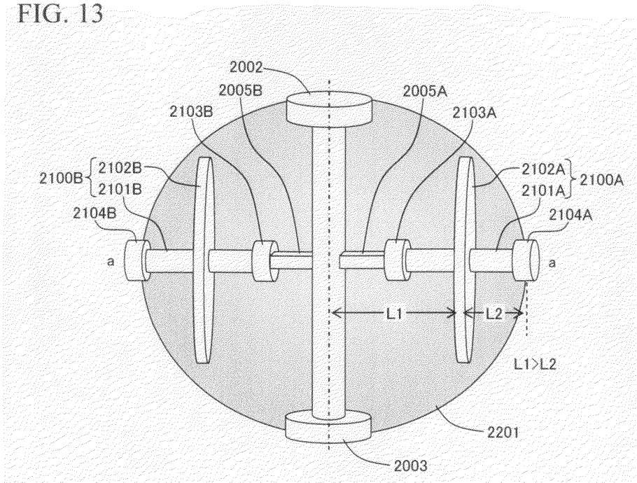

With reference to FIG. 13, a second example of a navigation body will be described. The navigation body of the example has the main rotary shaft 2001, the motor units 2002 and 2003 attached at both ends of the main rotary shaft, supports 2005A and 2005B attached on both sides of the main rotary shaft, the tops 2100A and 2100B attached to the supports, and a spherical cover 22001 for housing those components. The motor units 2002 and 2003 are provided with bearings rotatably supporting the main rotary shaft 2001.

The top 2100A has the shaft 2101A and the disc 2102A. The motor units 2103A and 2104A are attached at both ends of the shaft. The motor units 2103A and 2104A are provided with bearings rotatably supporting the shaft 2101A. The top 2100B is similar to the top 2100A.

The supports 2005A and 2005B are attached in the center of the main rotary shaft 20001. The axis of the top and the supports 2005A and 2005B are on a straight line. The navigation body of the example has a structure which is symmetrical with respect to the axis passing through the supports 2005A and 2005B.

The tops 2100A and 2100B are rotated by the motor units 2103A and 2104A and the motor units 2103B and 2104B, and the main rotary shaft 2001 is rotated by the motor units 2002 and 2003. The rotation moment and the centrifugal force act on the gravity center of the tops. The rotation moment is generated in the shaft of the top. By the rotation moment, the navigation body obtains upward thrust.

A distance from the gravity center of each of the tops to the center of the main rotary shaft 2001 is denoted by L1, and a distance from the gravity center of each of the tops to the outer end “a” is denoted by L2. The ratio of the two distances is denoted by “n”. That is, L1/L2=n. In this case, the arguments of the equations 1 to 4 hold good.

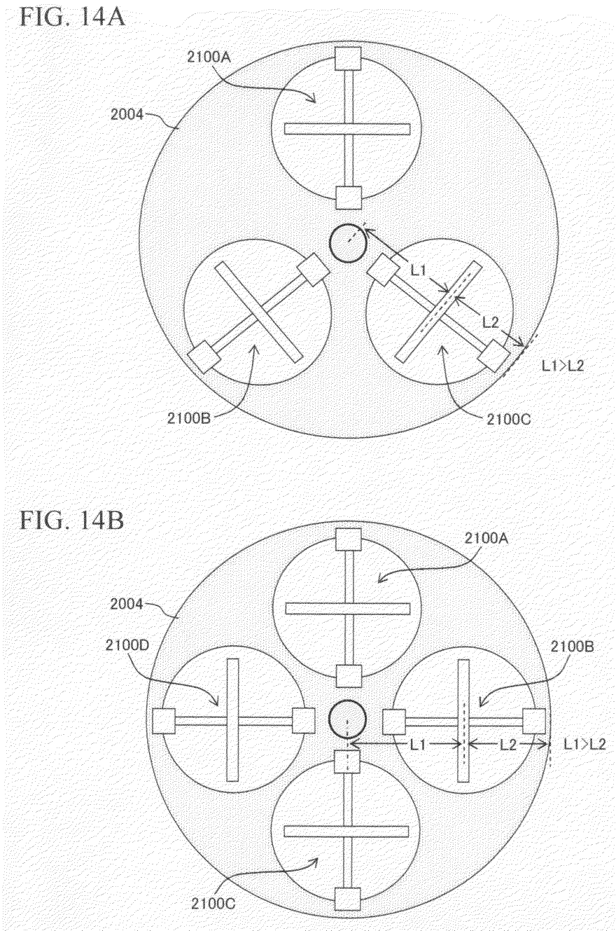

With reference to FIGS. 14A and 14B, a third example of a navigation body according to the present invention will be described. In the example of FIG. 14A, three tops 2100A, 2100B, and 2100C are provided. The tops are arranged at intervals of 120 degrees around the main rotary shaft. In the example of FIG. 14B, four tops 2100A, 2100B, 2100C, and 2100D are provided. The tops are arranged at intervals of 90 degrees around the main rotary shaft. In the examples, the shafts of the tops are arranged radially around the main rotary shaft. By increasing the number of tops, the thrust can be increased. In the examples, even if one top fails, the thrust of the navigation body can be generated.

A distance from the gravity center of each of the tops to the center of the main rotary shaft 2001 is denoted by L1, and a distance from the gravity center of each of the tops to the outer end of the disk 2004 is denoted by L2. The ratio of the two distances is denoted by “n”. That is, L1/L2=n. In this case, the arguments of the equations 1 to 4 hold good.

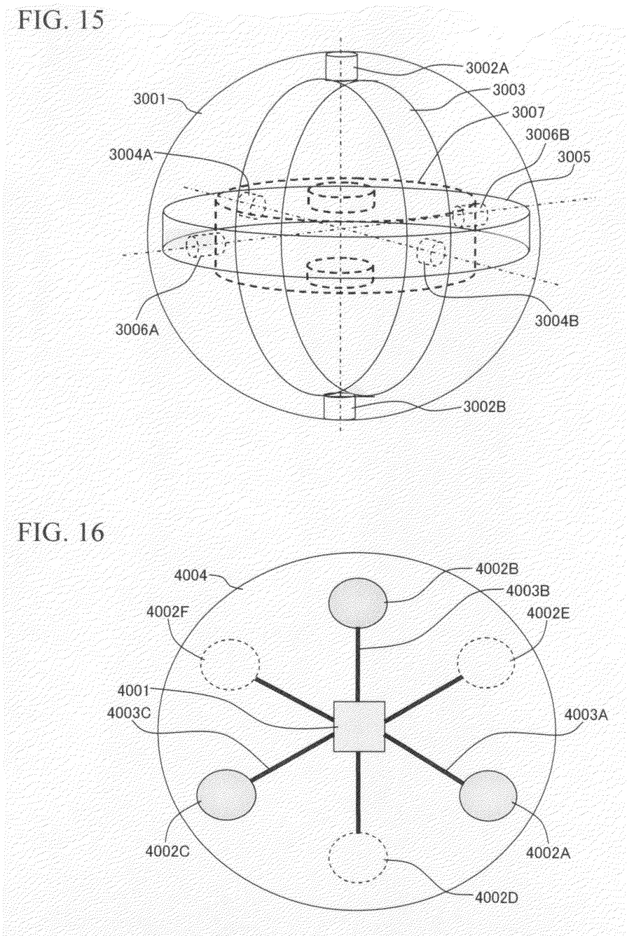

With reference to FIG. 15, a first example of the navigation device according to the present invention will be described. The navigation device of the example has a spherical cover 3001, an outer ring 3003 rotatably attached to the inner surface of the cover, an inner ring 3005 rotatably attached to the inner surface of the outer ring, and a thrust generator 3007 rotatably attached to the inner ring. The thrust generator 3007 shown by a broken line may be any of the navigation bodies shown in FIGS. 10, 13, and 14. The structure is not shown and its description will not be repeated.

Motor units 3002A and 3002B supported by the inner surface of the cover are attached at both ends of the outer ring 3003. The motor units 3002A and 3002B are provided with bearings rotatably supporting the outer ring 3003. Motor units 3004A and 3004B supported by the inner surface of the outer ring 3003 are attached at both ends of the inner ring 3005. The motor units 3004A and 3004B are provided with bearings rotatably supporting the inner ring 3005. Motor units 3006A and 3006B supported by the inner surface of the inner ring 3005 are attached at both ends of the thrust generator 3007. The motor units 3006A and 3006B are provided with bearings rotatably supporting the thrust generator 3007.

The outer ring 3003 is rotated by the motor units 3002A and 3002B with respect to the cover 3001, the inner ring 3005 is rotated by the motor units 3004A and 3004B with respect to the outer ring 3003, and the thrust generator 3007 is rotated by the motor units 3006A and 3006B with respect to the inner ring 3005.

A gimbal structure is formed by the outer ring 3003 and the inner ring 3005. Therefore, the outer ring 3003 rotates about a perpendicular axis, the inner ring 3005 rotates about a horizontal axis, and the thrust generator 3007 rotates about a rotation axis arranged in any position in space.

In the example, since the thrust generator is arranged in any position in space, thrust generated by the thrust generator is directed in any direction in space. That is, the navigation body of the example can generate thrust in any direction in space. Therefore, the navigation body of the example can move in any direction in outer space.

A second example of the navigation device according to the present invention will be described with reference to FIG. 16. The navigation device of the example has a controller 4001 arranged in the center, and three thrust generators 4002A, 4002B, and 4002C arranged symmetrically around the controller 4001. The controller and the thrust generators are connected via control cables 4003A, 4003B, and 4003C.

As shown by broken lines, three thrust generators 4002D, 4002E, and 4002F may be further provided. The controller 4001 has a function of supplying energy such as power to the thrust generators via the control cables 4003A, 4003B, and 4003C, and a function of transmitting control signals. Alternatively, the control cables 4003A, 4003B, and 4003C may be formed by pipes.

The thrust generators 4002A, 4002B, and 4002C are navigation bodies described with reference to FIG. 15. The thrust generators 4002A, 4002B, and 4002C can generate thrust in an arbitrary direction. Therefore, the navigation body of the example can navigate in an arbitrary direction.

The controller and the thrust generators are attached on a disc-shaped bottom face 4004. In addition, a semi-spherical cover for covering the controller and the thrust generators is used. An airtight chamber is formed by the bottom face 4004 and the semi-spherical cover.

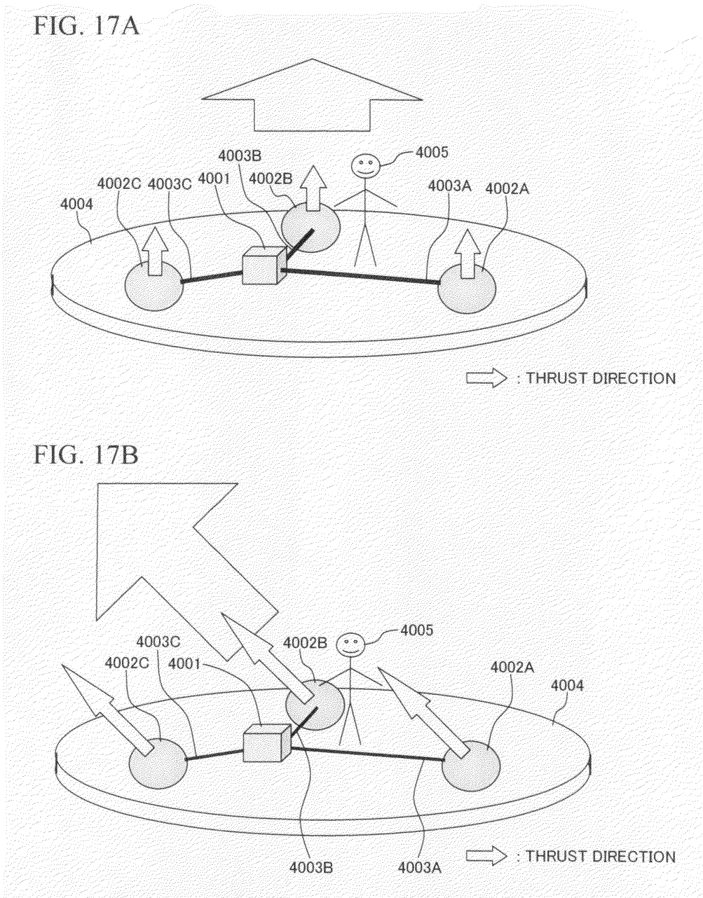

Referring to FIGS. 17A and 17B, the operation of the navigation device of FIG. 16 will be described. In the example of FIG. 17A, the three thrust generators 4002A, 4002B, and 4002C generate thrust perpendicular to the bottom face 4004 as shown by arrows. In the example of FIG. 17B, the three thrust generators 4002A, 4002B, and 4002C generate thrust tilted with respect to the bottom face 4004 as shown by arrows.

Also in the example, an airtight chamber is formed by the bottom face 4004 and a spherical cover. A person 4005 is in the airtight chamber.

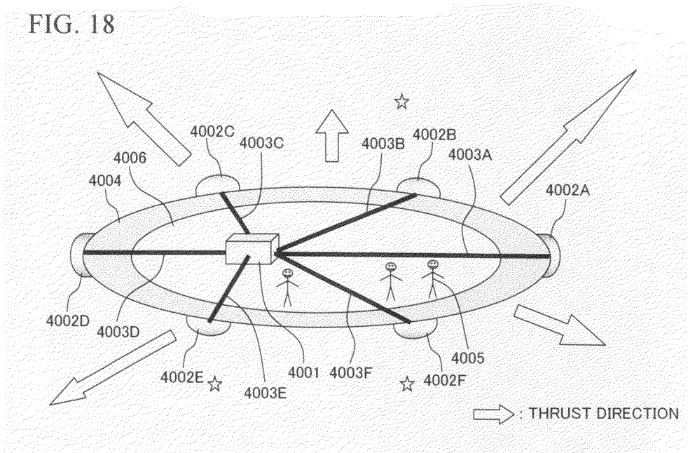

An example of a space navigation device according to the present invention will be described with reference to FIG. 18. The space navigation device of the example has a controller 4001 and a plurality of thrust generators 4002A to 4002F symmetrically arranged around the controller 4001. The controller and the thrust generators are connected to each other via control cables 4003A to 4003F.

In the space navigation device of the example, an airtight chamber is formed by a bottom face 4006 and a not-shown semispherical cover. People 4005 are in the airtight chamber. The thrust generators are arranged around the airtight chamber. The thrust generator is a navigation body described with reference to FIG. 16. The thrust generator can generate thrust in an arbitrary direction. Therefore, the navigation body of the example can navigate in arbitrary directions.

The thrust generator of the invention can generate thrust by itself, so that it can freely navigate in arbitrary directions at an arbitrary speed not only on the ground but also in outer space. Obviously, it can also navigate in the sea and lakes. In the case of navigating one's way in water, a sealing device such as a cover is necessary to prevent invasion of water in the thrust generator.

Although the examples of the present invention have been described above, it is obviously understood by a person skilled in the art that the invention is not limited to the examples but can be variously changed within the scope of the invention described in the scope of claims.

1. A navigation body comprising:
a rotation axis;
a plurality of tops symmetrically arranged around the rotation axis and each having a spinning axis arranged along a radial direction of the rotation axis; and
a motor device for rotating the tops around the rotation axis.

2. The navigation body according to claim 1, further comprising a disk rotating around the rotation axis,
wherein the plurality of tops are attached to the disk.

3. The navigation body according to claim 1, further comprising a rotary shaft using the rotation axis as a center axis, and a plurality of supports attached to the rotary shaft,
wherein the plurality of tops are attached to the supports.

4. The navigation body according to claim 1, further comprising an airtight container for covering the entire navigation body.

5. A navigation device comprising:
a thrust generator; and
a gimbal device for holding the thrust generator in any posture in space,
wherein the thrust generator is the navigation body comprising: a rotation axis; a plurality of tops symmetrically arranged around the rotation axis and each having a spinning axis arranged along a radial direction of the rotation axis; and a motor device for rotating the tops around the rotation axis.

6. A space navigation device comprising:
a controller;
a plurality of thrust generators;
cables for connecting the controller and the thrust generators; and
an airtight container for housing the controller, the thrust generators, and the cables,
wherein each of the thrust generators is the navigation body comprising: a rotation axis; a plurality of tops symmetrically arranged around the rotation axis and each having a spinning axis arranged along a radial direction of the rotation axis; and a motor device for rotating the tops around the rotation axis or the navigation device comprising a thrust generator; and a gimbal device for holding the thrust generator in any posture in space.
